(19) United States
(12) Patent Application Publication
(10) Pub. No.: US 2003/0163510 A1
(43) Pub. Date: Aug. 28, 2003

(54) Method of administering user access to application programs on a computer system

(76) Inventor: Bob Janssen, Lage Zwaluwe (NL)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 10/086,818

(22) Filed: Feb. 28, 2002

(51) Int. Cl. G06F 9/00

(52) U.S. Cl. 709/100

(57) ABSTRACT

A method of administering user access to application programs on a computer system comprises providing a user database, a database of tasks and a user-specific list of allowed tasks, comprising allowed application programs, configuring the list of allowed tasks on the basis of the user database and the database of tasks, detecting a command to execute a task, and preventing execution of tasks that are not on the list of allowed tasks.

### BACKGROUND OF THE INVENTION

1. Field of the Invention

The invention relates to a method of administering user access to application programs on a computer system. The invention relates particularly to those methods comprising providing a user-specific list of allowed tasks, including allowed application programs.

2. Brief Description of the Prior Art

In one known method of administering user access, a system administrator is responsible for maintenance of a list of allowed tasks for each user. Every time execution of a task is initiated, the list of allowed tasks for the user is consulted. A task on the list is allowed to proceed, one that is not is prevented from being executed. The sort of network environment in which the method is commonly used allows access to a great number of users, so a large number of lists are kept.

The known method suffers from the disadvantage that compiling lists of allowed applications for the users is a lot of work for the system administrator. System administrators will often use standard user profiles to decrease the amount of work.

However, this makes the system inflexible, since lists cannot be easily adapted to individual user needs, and the addition or removal of application programs to or from the system requires all the lists to be manually re-compiled.

### BRIEF SUMMARY OF THE INVENTION

The invention provides a method of administering user access to application programs and a computer system and computer program that allow flexible adaptation to user requirements, but are easy to use for a system administrator.

The method of administering user access to application programs on a computer system comprises providing a user database, a database of tasks and a user-specific list of allowed tasks, comprising allowed application programs, configuring the list of allowed tasks on the basis of the user database and the database of tasks, detecting a command to execute a task, and preventing execution of tasks that are not on the list of allowed tasks.

According to another aspect of the invention, a computer system is provided, comprising means for generating a user-specific list of allowed tasks, comprising allowed application programs, means for detecting a command to execute a task, means for preventing execution of tasks that are not on the list of allowed tasks, a user database and a database of tasks, and means for configuring the list of allowed tasks on the basis of the user database and the database of tasks.

The computer system has the advantage of being easy to administer. It can be flexibly adapted to changing user requirements

According to a further aspect of the invention, a computer program is provided, comprising one or more routines for generating a user-specific list of allowed tasks, comprising allowed application programs, one or more routines for detecting a command to execute a task, one or more routines for preventing execution of tasks that are not on the list of allowed tasks, one or more routines for reading a user database and a database of tasks, and one or more routines for configuring the list of allowed tasks on the basis of the user database and the database of tasks.

The computer program may be the implementation of one or more embodiments of the method of the invention, providing a system administrator with a primarily automatic way of managing the system.

### BRIEF DESCRIPTION OF THE SEVERAL VIEWS OF THE DRAWINGS

The invention will now be explained in further detail with reference to the drawings.

FIG. 1 shows a schematic diagram of a distributed computer system, suitable for using an embodiment of the method according to the invention.

FIG. 2 shows a schematic diagram illustrating the configuration of the list of allowed tasks in an embodiment of the method.

FIG. 3 shows an action diagram illustrating how the invention is used to determine whether a task should be executed.

### DETAILED DESCRIPTION OF THE INVENTION

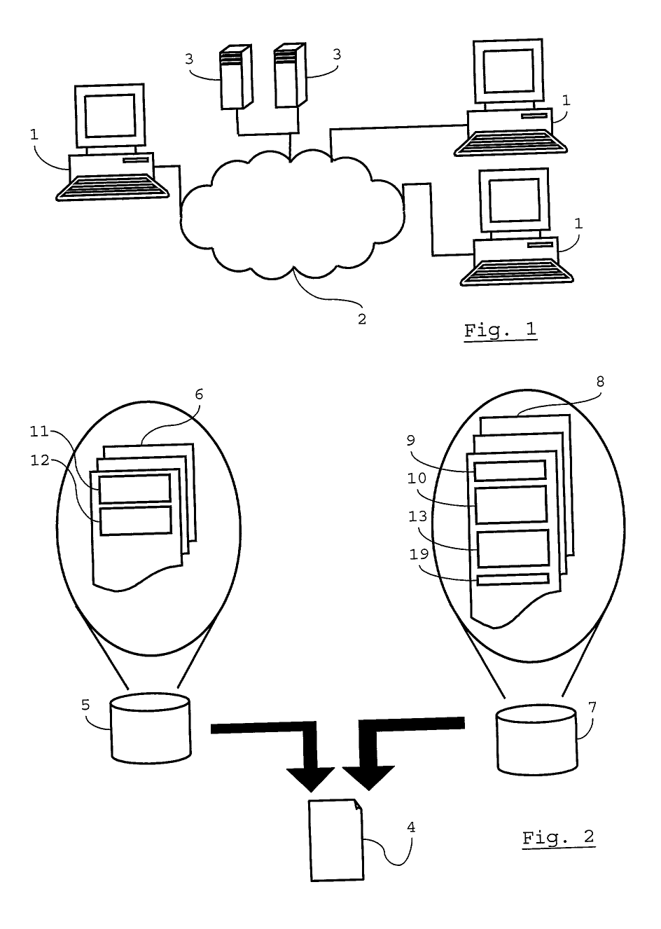

In a first embodiment, the invention provides a method of administering user access to application programs on a computer system. Although it is not limited to any particular kind of computer system in principle, the environment schematically illustrated in FIG. 1 is an example of a computer system in which it can be deployed to particular advantage. The system comprises a plurality of computer terminals 1, connected to a network 2. Servers 3 are also attached to the network 2.

In certain embodiments of the method, system security is ensured, since unknown tasks cannot be run. The system is also flexible, since the list can be changed often. New applications can be added to the database of tasks. The list will then automatically be updated. New users can be added to the user database. A list of allowed tasks will automatically be generated for that user. Uninstalling application programs can be efficiently accomplished, since the associated task(s) need only be removed from the database of tasks. The lists of allowed tasks are automatically configured without the application program.

Preferably, the list of allowed tasks is configured at least once every time a user has entered a request to log on to the computer system.

Thus, the list is kept up to date. Since the system administrator is not directly involved in the configuration, frequent changes to user access rights can be made without burdening the system administrator. The list evolves dynamically.

In a preferred embodiment, the database of tasks comprises information linking tasks to other tasks that can invoke the tasks during execution of an application program.

Thus, certain embodiments of the method of the invention are capable of handling modular applications, which comprise a plurality of utility programs. If a main program on the list of allowed tasks calls such a utility program, execution of the utility program is not prevented.

In a further embodiment of the method of the invention, in a simulation mode, at least one task that is not on the list of allowed tasks is allowed to execute, and tasks started during execution are registered.

Thus, certain embodiments of the method can be phased in with minimum disruption to the organisation using it. The user database and the database of tasks can be set up in a mainly automatic way, since the registration is available to provide the necessary details.

In a preferred embodiment, a plurality of user groups are defined, a group membership list is provided with the user database for each user, links are provided between the tasks in the database of tasks and the groups, and the links and the group membership list are used to configure the list of allowed tasks.

Thus, users can inherit access rights accorded to particular groups. Because the group membership list is provided, a user can simultaneously be a member of several groups. His list of allowed tasks is the collocation of the access rights of the groups of which he is a member.

In a further embodiment, prevention of the execution of an application program or task is registered, and a notification of the prevention is sent to a system administrator.

Thus, the system administrator has the necessary information to be able to respond to user complaints. Additionally, the system administrator can alter the access rights, if it transpires the task is useful to the user concerned.

In yet a further embodiment, one or more tasks of which the execution should never be prevented are defined in the database of tasks, and execution of such a task is also not prevented if it is not on the list of allowed tasks.

Thus it is possible to keep the list of allowed tasks short, making it easier to search the list. Additionally, certain tasks critical to the correct functioning of the system cannot be overlooked.

The method of the present invention can also be used on computer systems comprising a single computer terminal 1, which need not be connected to a network 2.

There are no principal limitations to the size of the computer system. The invention can equally be used in computer systems with several hundred or several thousand computer terminals 1. The network 2 can be a Local Area Network, a Wide Area Network, or a corporate Intranet, for example, which could be global.

The invention can in principle be used in conjunction with multiple operating systems. It can be part of the operating system(s), or it can run as middleware.

A common characteristic of all the types of computer system just described is that several users are able to use the system. The system is able to identify each user, for example by means of a user name entered by a user when he logs on to the system on one of the computer terminals 1.

A number of application programs are installed on the computer system. An application program in this context is a program designed to perform a specific function directly for the user or, in some cases, for another application program. Examples of application programs are word processing programs, programs for computer aided design, programs to operate a scanner, and programs to access files stored on a disk. Application programs use the services of the computer's operating system and other supporting application programs, amongst others to access resources, such as external and internal devices.

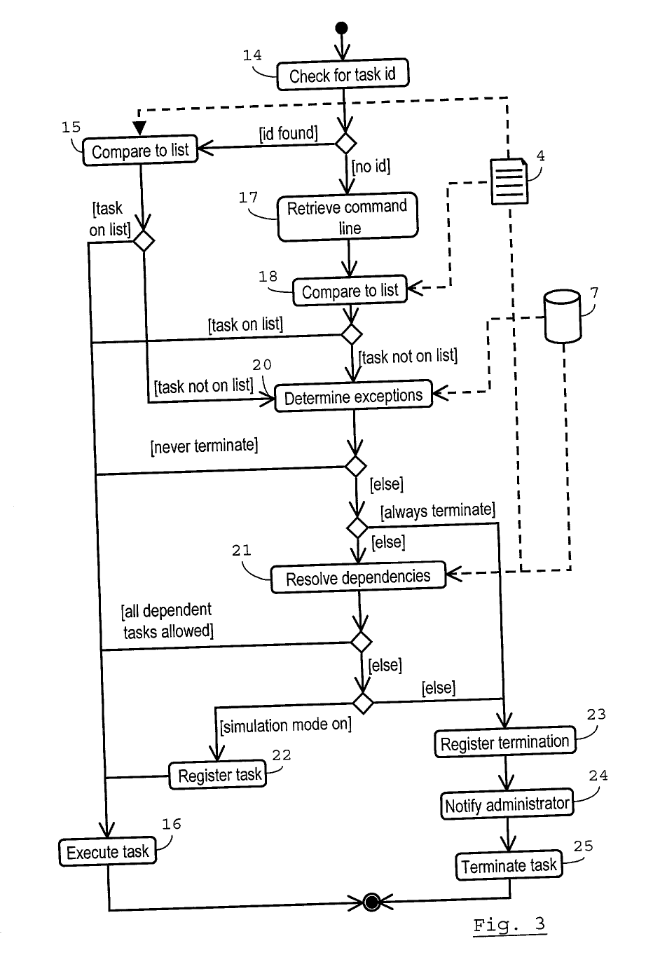

Because a particular user should not be able to use all the programs, a user-specific list 4 of tasks, depicted symbolically in FIGS. 2 and 3, is provided, specifying tasks that the system is allowed to execute for the user. A task is a basic unit of programming that an operating system controls. It can be the entire application program or a utility program invoked by another program. In a typical computer system, the tasks are incorporated in files. These can be binary files, comprising code that can be executed by a computer processor, or code that can be interpreted. The file can comprise a script with instructions for the operating system, or a library of programs that can be dynamically linked to another program. The file can also be a device driver, used by an application program or the operating system to access a hardware component in the system.

As part of the invention, every time execution of a task is initiated, either directly by a user or indirectly by another application program, the list 4 of allowed tasks is consulted. As a general rule, if the task is not on the list 4 of allowed tasks, execution of that task is prevented. In the context of the present application, execution of a task is considered to be prevented when none of the processes started by the task are loaded into memory or when execution of these processes is terminated soon after they have been created by the operating system of the computer. The exact mechanism by which detection and prevention of the execution of tasks is accomplished, and possible exceptions to the general rule that execution of a task not on the list 4 of allowed tasks is prevented, will be detailed below.

The use of the list 4 of allowed tasks and consultation of that list 4 when execution of a task is initiated is to be preferred over other methods of administering user access to application programs. For example, methods exist, wherein an interface is used that only displays allowed application programs to a user. In practice, however, the user can get around the interface, for example by starting an application program directly from a command line or by writing a program or macro that invokes an unauthorised program. Another common method is to accord access rights to each executable file, for example specifying whether only the creator of the file, a certain user group or every user should be allowed to run it. This, however, does not preclude files copied onto the system by a user or sent to a user in an electronic mail message from being run if the access rights accorded to the file allow this.

Creating and maintaining the list 4 of tasks is the responsibility of one or more system administrators or so-called super-users. Although it is possible that a separate list 4 is created by manually entering all allowed tasks, this would be a lot of work. Some prior art systems provide a set of standard lists for certain types of users. This is a very inflexible method, since users take on new roles and responsibilities within an organisation from time to time. To adequately take account of all the different combinations of user roles and responsibilities and the associated access privileges would require a very large number of standard users, thus still causing the system administrator a lot of work. Also considering that changes in hardware configuration, leading to resources being temporarily unavailable, cannot be taken into account, and the need for a more flexible and easy to manage system will be clear.

The invention relieves the system administrator of much of the work involved in creating the user-specific list 4 of allowed tasks, enabling a large part of the process to be carried out automatically. A user database 5 is provided, comprising a user profile 6 for each user. The user profile 6 can be adapted, and must be updated by the system administrator. The invention provides a number of ways to simplify this, as will be explained in detail below. A database 7 of tasks is also provided. The database 7 of tasks comprises a plurality of task records 13.

The list 4 of allowed tasks is configured automatically on the basis of the user's user profile 6 in the user database 5 and the database 7 of tasks. Thus, a system administrator can install a new application program without having to update all the user profiles 7. Only the database 7 of tasks must be updated through the addition of one or more task records 13. Similarly, the addition or alteration of a user profile 6 does not require the system administrator to collate the information on the available tasks, sifting through them to generate the list 4 of allowed tasks. This is taken care of by the system administration program, provided as part of the invention.

A problem might occur if a task that is on the list 4 of allowed tasks provided for a user is no longer available, because, for example, it has been uninstalled or because the user should no longer be allowed to use it. According to the invention, the list 4 of allowed tasks is configured at least once every time a user has entered a request to log on to the computer system. This can be carried out as part of the log-on procedure, or on several occasions during the period in which the user is logged on. Thus, account can be taken of any changes in either the user database 5 or the database of tasks 6. If a particular device has been disconnected from the network 2, for example, a simple modification to the task record 8 of its driver in the database 7 of tasks, suffices to ensure that the user is not confronted with an inaccessible device. Temporary removal of application programs or devices thus becomes a very simple matter. Similarly, short-term changes can be made to a user profile 6, automatically leading to a change in the list 4 of allowed tasks.

The task record 8 of a task comprises a task id 9 that uniquely identifies the task. The task id 9 is allocated by the program provided as part of the invention.

The task record 8 of a task further comprises a list 10 of access rights. The access rights define conditions that must be met for the system to execute the task.

The list 10 of access rights can, for example, comprise information specifying time intervals in which a task may be executed. If this is the case, the list 4 of allowed tasks is configured on the basis of this information and the time indicated by a system clock. Because the list 4 of tasks is configured at least once every time a user has entered a request to log on to the computer system, it is possible to thus allow particular users access to certain application programs only at certain times during the day. A possible use of this feature is to allow Internet access only outside office hours. It is also possible to limit use of an application program to a certain maximum time interval per day or per week.

The invention allows the system administrator to specify user groups. These groups can be based on the structure of the organisation deploying the computer system. For example, there could be a group for each project team, each product division, each location, etc.

A set of tasks that the computer system should be able to execute for members of a user group is defined by the administrator in the process. The user profile 6 comprises a group membership list 11, detailing the groups of which the user is a member. The system administration program of the invention is used to enter the groups in the list 10 of access rights of each of the tasks in the set of tasks for the user group. Thus, links are provided between the tasks in the database 7 of tasks and the groups. The group membership list 11 and the links are used to configure the list 4 of allowed tasks.

If a new project team is created, for instance, the system administrator can create a new user group for this team. The group membership list 11 is updated for each of the members. The list 10 of access rights for each of the tasks accessible by the group is also modified. The system is very flexible. The group membership list 11 allows a user to simultaneously be a member of several groups. Removal of a user from the group only requires the alteration of one user profile 7. The list 4 of allowed tasks for that user is automatically reconfigured. The system administrator need not at that point determine the tasks that should no longer be accessible, and manually remove them one by one from the list 4 of allowed tasks. If a task is no longer needed by the group, only one task record 8 need be modified. The lists 4 of allowed tasks are automatically updated.

The system administrator can also define user functions. The system administrator specifies which tasks or application programs a user with the defined user function should be allowed to execute. The user profile 6 comprises a user function record 12, detailing the functions the user performs. The system administration program of the invention updates the list 10 of access rights whenever a new user function is created, or access rights are added or removed for a user function.

Due to the use of a user function record 12, a user can perform several functions and receive the associated access rights. For example, the user could be a draughtsman and a team leader. His list 4 of allowed tasks would then comprise computer aided design applications and a scheduling program, for instance.

The list 10 of access rights can also comprise information detailing locations from which a task is allowed to be run. As part of this feature of the invention, the computer terminal 1 on which a user has logged on to the system is registered when the request to log on to the system is made. Subsequently, the list 4 of allowed tasks is automatically configured at least once on the basis of the location-dependent information in the list 10 of access rights and the registered computer terminal 1.

Because the computer terminal 1 is registered the system administration program ‘knows’ where the user is. Because the list 10 of access rights comprises location-dependent information, the system administration program ‘knows’ what is possible at that location. Because the list 4 of allowed tasks is configured at least once every time a user has entered a request to log on to the system, the list 4 of allowed tasks is always up to date and adapted to the location of the user.

The user can thus move from location to location without being confronted with slow or non-functioning application programs. For example, the list 10 of access rights can specify that a graphics program should only be able to execute on a terminal 1 with a high-powered graphics card and a large screen. Similarly, certain application programs are only useful on a notebook, or on a computer terminal 1 at an employee's home. Printer drivers can be provided only to users in the vicinity of the device.

Many application programs are of a modular nature. They do not consist of a single executable binary, but instead comprise a whole group of binaries, dynamically linked libraries, device drivers, etc. Such utility programs are called by the main binary at various stages of its execution. In addition many application programs are part of a suite and share binaries with other application programs in the suite. This potentially forms a problem, since each of the utility programs is a separate task, in addition to the task formed by the main application program. The invention provides a means for ensuring that both the main application program and all the utility programs used by it can be executed.

The task record 8 also comprises a list 13 of dependent tasks. Dependent tasks in this embodiment are tasks that can invoke the task for which the task record 8 is defined. In this way, the database 7 of tasks comprises information linking tasks to other tasks that can invoke the tasks during execution of an application program. The information could be used to add dependent tasks to the list 4 of allowed tasks. In the embodiment further to be described below, the database 7 of tasks is directly consulted for the information.

In FIG. 3, the way in which a task is processed is schematically explained. The system administration program provided as part of the invention comprises one or more modules that run in the background. The flow chart of FIG. 3 is run through every time a message is passed to these modules indicating that a task has been initiated. Messaging can be event-driven or time-driven. The invention does not rely on any one method, and can be adapted to work with any mechanism most suited to the particular operating system.

For example, the system administration program can install a system-wide hook that generates a message to the modules running in the background every time a new task is initiated. This works by injecting a hook callback procedure in the address space of the operating system. Every time a message to execute a task is sent to the operating system, the callback procedure is executed first passing the message to a module of the system administration program.

In a different implementation, a device driver is used to handle calls to the operating system kernel. Each call that contains an instruction to execute a task is suspended until the system administration program has determined that it may be passed to the operating system kernel. The device driver is linked to the operating system when the computer terminal 1 is booted, or it is compiled with the kernel of the operating system, depending on the particular operating system in use.

In a time-driven implementation, the operating system is repeatedly polled to generate a list of tasks that have been initiated.

A task can be initiated directly by a command from a user, or by one from another task. The program comprises routines for detecting commands to execute a task. The user can issue such a command in several ways. For example, the user can enter a command on a command line. Alternatively a graphical user interface can be used. The user can then use a pointer to select an application program. In an advantageous embodiment of the invention, the system administration program is part of a suite of programs, including a graphical user interface. In this embodiment, both the GUI and the system administration program use the task id 9 to refer to tasks.

Once the process has been initiated, the task must be identified. Where the GUI uses the task id 9 to refer to tasks, the task id 9 is passed to the system administration program, which in a first step 14 checks for availability of the task id 9, and in a subsequent step 15 compares it to the list 4 of allowed tasks. If the task is on the list 4, it may be executed in step 16. Otherwise, if no task id 9 is present, the command line is retrieved in an alternative step 17, and the command to execute the task is compared to the list 4 of allowed tasks in a step 18. Again, if the task is on the list 4, the process moves onto the step 16 of executing the task.

In principle, if a task is not on the list 4, then its execution is prevented. However, certain tasks that are not on the list 4 can still be allowed to execute. A system administrator may have overseen a task that a certain organisational unit should have at its disposal. Certain tasks are critical to the system and should be allowed to execute for every user. Tasks accessible to every user need not be on the list 4, since this would only make the list 4 longer. Steps 15 and 18 would thus take longer to complete than necessary. Instead, according to the invention, one or more tasks of which the execution should never be prevented are defined in the database 7 of tasks, and execution of such a task is also not prevented if it is not on the list 4 of allowed tasks. In the embodiment here described, the task record 8 in the database 7 comprises an exception/dependency field 19. In this field, a flag can be set, marking the task as a ‘never terminate’ task. Step 20 in the process of FIG. 3 consists of determining the content of the exception/dependency field 19. If the field 19 contains a ‘never terminate’ flag, then the task is executed, even if it is not on the list 4 of allowed tasks.

Certain tasks should never be available to any of the users. These could be tasks that can lead to instability or insecurity of the system, for example. As an extra security measure, for use in conjunction with a so-called ‘simulation mode’, which will be further explained below, one or more tasks of which the execution should always be prevented are defined in the database 7 of tasks. Execution of such a task is always prevented. For this purpose, the exception/dependency field 19 can also contain an ‘always terminate’ flag, which is also detected in step 20.

If neither of the two exceptions is applicable, but the task is not on the list 4 of allowed tasks, the dependencies are resolved in a further step 21. The system consults the database 7 of tasks to read the list 13 of dependent tasks. It checks the list 4 of allowed tasks to see if any of the dependent tasks are on it. If this is the case, the initiated task is allowed to execute in step 16.

Tasks that are not on the list 4 of allowed tasks, that do not fall under the ‘never terminate’ exception, and are not linked to a dependent task on the list 4 of allowed tasks are not allowed to execute when the system is fully operational. However, the system administration program comprises an additional feature that is designed to help the system administrator set up the system. The system administration program can be run in a simulation mode. In this mode, at least one task that is not on the list 4 of allowed tasks is allowed to execute, and tasks started during execution are registered.

If the simulation mode is switched on, a task of which the execution would normally have been prevented is registered in a step 22 subsequent to the step 21 in which dependencies have been determined. Then, the task is allowed to execute in step 16. The simulation mode is a useful feature for compiling the user database 5 and the database 7 of tasks. Because tasks are not prevented from being executed, unless they are of the ‘always terminate’ type, organisations in which the method of the invention is first being implemented are not severely disrupted during the set-up phase.

Because tasks of which the execution should always be prevented can be defined in the database of tasks, and execution of such a task is prevented in the simulation mode, the simulation mode does not make the system vulnerable.

The simulation mode feature can, for example be used to automatically compile the list 13 of dependent tasks in the task record 13. For example, a utility program, started by an application program, is registered, together with the application program. Whereas, in the normal mode, the utility program would not have been allowed to run if it wasn't on the list 4 of allowed tasks, or if its list 13 of dependent tasks didn't contain the application program, in the simulation mode, it can continue. The fact that it is linked to the application program is registered in step 22, so that the application program can be added to the list 13 of dependent tasks of the utility program, or the user or user group can be added to the list 10 of access rights.

The simulation mode is also useful for determining which applications are used by which users. A system administrator can use this information to adjust the list 10 of access rights, without having to consult the user directly.

The normal, non-simulation, mode also comprises a step 23 in which tasks of which the execution is to be prevented are registered. In a subsequent step 24, the administrator is sent a notification, before execution of the task is prevented in a final step 25. The notification sent in step 24 can be in one of a variety of shapes. For example an e-mail or similar electronic message can be sent to the system administrator, or a list of failed attempts to execute a forbidden task can be kept. Because prevention of the execution of an application program or task is registered and notification of the prevention is sent to a system administrator, the system administrator is automatically supplied with extra information. The information can be used to warn users, but also to alter the list 10 of access rights of the task concerned, to allow the particular user to execute the task. The information is also useful if a helpdesk is being run, since a complaint from a user can easily be traced. Thus, execution of the task is prevented, but the system administration program is also used to administer user access rights in an easy and flexible way.

It will be apparent to the person skilled in the art that the invention is not limited to the embodiments described above. For example, although the list of dependent tasks details tasks that can invoke a task, a symmetrical arrangement, wherein a list of tasks that can be invoked by the task for which the task record is defined would also be possible.

Additionally, the list of allowed tasks can evolve dynamically in many ways, not just through the adjustment of group membership and user function lists. For example, certain tasks can be allowed only at certain times or on certain days.

1. A method of administering user access to application programs on a computer system, comprising providing a user database, a database of tasks and a user-specific list of allowed tasks, comprising allowed application programs, configuring the list of allowed tasks on the basis of the user database and the database of tasks, detecting a command to execute a task, and preventing execution of tasks that are not on the list of allowed tasks.

2. A method according to claim 1, wherein the list of allowed tasks is configured at least once every time a user has entered a request to log on to the computer system.

3. A method according to claim 2, wherein the database of tasks comprises information specifying time intervals in which a task may be executed, comprising configuring the list of allowed tasks on the basis of this information and the time indicated by a system clock.

4. A method according to claim 1, wherein the database of tasks comprises information linking tasks to other tasks that can invoke the tasks during execution of an application program.

5. A method according to claim 1, wherein, in a simulation mode, at least one task that is not on the list of allowed tasks is allowed to execute, and tasks started during execution are registered.

6. A method according to claim 2, wherein the computer system is a distributed computer system comprising a plurality of computer terminals connected to a network, and wherein the database of tasks comprises location-dependent information, the method comprising registering the terminal on which the user has entered the request and configuring the list of allowed tasks on the basis of the location-dependent information and the registered terminal.

7. A method according to claim 1, wherein a plurality of user groups are defined, a group membership list is provided with the user database for each user, links are provided between the tasks in the database of tasks and the groups, and the links and the group membership list are used to configure the list of allowed tasks.

8. Method according to claim 7, wherein a plurality of user functions are defined, a user function list is provided with the user database for each user, links are provided between the tasks in the database of tasks and the user functions, and the links and the user function list are used to configure the list of allowed tasks.

9. A method according to claim 1, wherein prevention of the execution of an application program or task is registered, and wherein a notification of the prevention is sent to a system administrator.

10. A method according to claim 1, wherein one or more tasks of which the execution should never be prevented are defined in the database of tasks, and wherein execution of such a task is also not prevented if it is not on the list of allowed tasks.

11. Method according to claim 5, wherein one or more tasks of which the execution should always be prevented are defined in the database of tasks, and wherein execution of such a task is prevented in the simulation mode.

12. A computer system comprising means for generating a user-specific list of allowed tasks, comprising allowed application programs, means for detecting a command to execute a task, means for preventing execution of tasks that are not on the list of allowed tasks, a user database and a database of tasks, and means for configuring the list of allowed tasks on the basis of the user database and the database of tasks.

13. A computer system according to claim 12, programmed to configure the list of allowed tasks at least once every time a user has entered a request to log on to the computer system.

14. A computer system according to claim 12, wherein the database of tasks comprises information linking tasks to other tasks that can invoke the tasks during execution of an application program.

15. A computer system according to claim 12, capable of being run in a simulation mode in which mode the computer system is programmed to allow at least one task that is not on the list of allowed task to execute and to register tasks started during execution.

16. A computer system according to claim 12, comprising means for defining a plurality of user groups, and a group membership list, stored with the user database, for each user, wherein information linking tasks to the groups is comprised in the database of tasks for each task, the computer system being programmed to use the links and the group membership list to configure the list of allowed tasks.

17. A computer program comprising one or more routines for generating a user-specific list of allowed tasks, comprising allowed application programs, one or more routines for reading a user database and a database of tasks, and one or more routines for configuring the list of allowed tasks on the basis of the user database and the database of tasks, one or more routines for detecting a command to execute a task, and one or more routines for preventing execution of tasks that are not on the list of allowed tasks.

18. A computer program according to claim 17, which, when run, configures the list of allowed tasks at least once every time a user has entered a request to log on to the computer system.

19. A computer program according to claim 17, capable of being run in a simulation mode in which mode at least one task that is not on the list of allowed tasks is allowed to execute and tasks started during execution are registered.

20. A computer program according to claim 17, comprising one or more routines for defining a plurality of user groups, one or more routines for reading a group membership list, stored with the user database, for each user, and one or more routines for retrieving information linking tasks to the groups, comprised in the database of tasks for each task, which program, when run, is capable of using the links and the group membership list to configure the list of allowed tasks.
